(19) United States
(12) Patent Application Publication
(10) Pub. No.: US 2011/0128244 A1
(43) Pub. Date: Jun. 2, 2011

(54) MOBILE DEVICE AND METHOD FOR OPERATING THE TOUCH PANEL

(75) Inventors: Kwang Hyun CHO, Suwon-si (KR); Jin Goo LEE, Seoul (KR); Pil Kyoo HAN, Suwon-si (KR)

(73) Assignee: SAMSUNG ELECTRONICS CO. LTD., Suwon-si (KR)

(21) Appl. No.: 12/944,885

(22) Filed: Nov. 12, 2010

(30) Foreign Application Priority Data
Dec. 1, 2009 (KR) 10-2009-0117889

(51) Int. Cl. G06F 3/041

(52) U.S. Cl. 345/173

(57) ABSTRACT

A mobile device with a touch screen and a method for operating the touch panel are provided. The mobile device includes a touch panel and a controller. The touch panel divides the area into first and second areas, where the size of the first area corresponds to that of a display unit. The controller performs user functions according to touch events that occur on the first and second areas. The mobile device can increase the usable space in the installation of the touch screen. The method can efficiently operate the touch panel of the touch screen.

### PRIORITY

This application claims the benefit under 35 U.S.C. §119(a) of a Korean patent application filed on Dec. 1, 2009 in the Korean Intellectual Property Office and assigned Serial No. 10-2009-0117889, the entire disclosure of which is hereby incorporated by reference.

### BACKGROUND OF THE INVENTION

1. Field of the Invention

The present invention relates to mobile devices. More particularly, the present invention relates to a mobile device with a touch screen and a method for operating the touch screen.

2. Description of the Related Art

Mobile devices are widely used because they can be easily carried around and they provide a variety of user functions. Mobile devices employ various types of input modes in order to support user functions. In recent years, most mobile devices have been equipped with a touch screen, which is configured to include a touch panel and touch sensors.

The touch screen divides the area into a display area and a periphery area. The display area refers to an area for a display screen installed to the touch screen, where the display screen displays information to the user. The periphery area refers to an area where peripheral components for operating the display screen are placed. The periphery area does not perform a display function. Therefore, the touch panel of the touch screen is installed to the mobile device, matching the area of the display screen. That is, conventional touch screens are disadvantageous in that they do not utilize the peripheral area as an input and/or output function.

Therefore, a need exists for a mobile device that allows efficient use of the area to which the touch screen is installed by providing an input and/or output function on the peripheral area of the touch screen.

### SUMMARY OF THE INVENTION

An aspect of the present invention is to address at least the above-mentioned problems and/or disadvantages and to provide at least the advantages described below. Accordingly, an aspect of the present invention is to provide a mobile device that allows efficient use of the area to which the touch screen is installed.

Another aspect of the present invention is to provide a method for operating a touch panel of a mobile device.

In accordance with an exemplary embodiment of the present invention, a mobile device is provided. The mobile device includes a touch panel and a controller. The touch panel divides the area into first and second areas, where the size of the first area corresponds to that of a display unit. The controller performs user functions according to touch events that occur on the first and second areas.

In accordance with another exemplary embodiment of the present invention, a method for operating a touch panel that has an area larger than a display unit is provided. The method includes dividing the area of the touch panel into first and second areas, where the size of the first area corresponds to that of a display unit, detecting touch events that occur on the first and second areas, and performing a particular user function according to the touch event.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a schematic block diagram of a mobile device according to an exemplary embodiment of the present invention;

FIGS. 2A and 2B illustrate examples of a touch screen according to an exemplary embodiment of the present invention;

FIG. 3 is a flowchart that describes a method for operating a touch panel of a mobile device according to an exemplary embodiment of the present invention;

FIG. 4 illustrates display screens of a mobile device when a user manages a file management program in the mobile device according to an exemplary embodiment of the present invention;

FIG. 5 is a flowchart that describes a method for operating a file management program of a mobile device according to an exemplary embodiment of the present invention;

FIG. 6 illustrates a display screen of a mobile device when a user manages a Digital Multimedia Broadcast (DMB) receiving program according to an exemplary embodiment of the present invention; and

FIG. 7 is a flowchart that describes a method for operating a Digital Multimedia Broadcast (DMB) receiving program, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Prior to explaining exemplary embodiments of the present invention, terminologies will be defined for the present description below. The terms or words described in the present description and the claims should not be limited by a general or lexical meaning, instead should be analyzed as a meaning and a concept through which the inventor defines and describes the invention at his most effort, to comply with the idea of the invention. Therefore, one skilled in the art will understand that the embodiments disclosed in the description and configurations illustrated in the drawings are only exemplary embodiments, and that there may be various modifications, alterations, and equivalents thereof to replace the embodiments at the time of filing this application.

In the following description, although an exemplary embodiment of the present invention is explained based on a mobile device equipped with a touch screen, it should be understood that the invention is not limited thereto. It will be appreciated that the invention can be applied to all information communication devices, multimedia devices, and their applications, for example, a mobile communication terminal, a Portable Multimedia Player (PMP), a Personal Digital Assistant (PDA), a smart phone, an MP3 player, a mini Personal Computer (PC), etc.

A touch down event occurs when a user's finger or an object touches on the display unit to which touch sensors are installed. A drag event occurs when a user's finger or an object moves on the touch panel in a certain direction, without losing contact. A touch up event occurs when a user's finger or an object is removed from the touch panel. In this application, the term “touch event” refers to a general term representing the “touch down event,” “drag event” and “touch up event.”

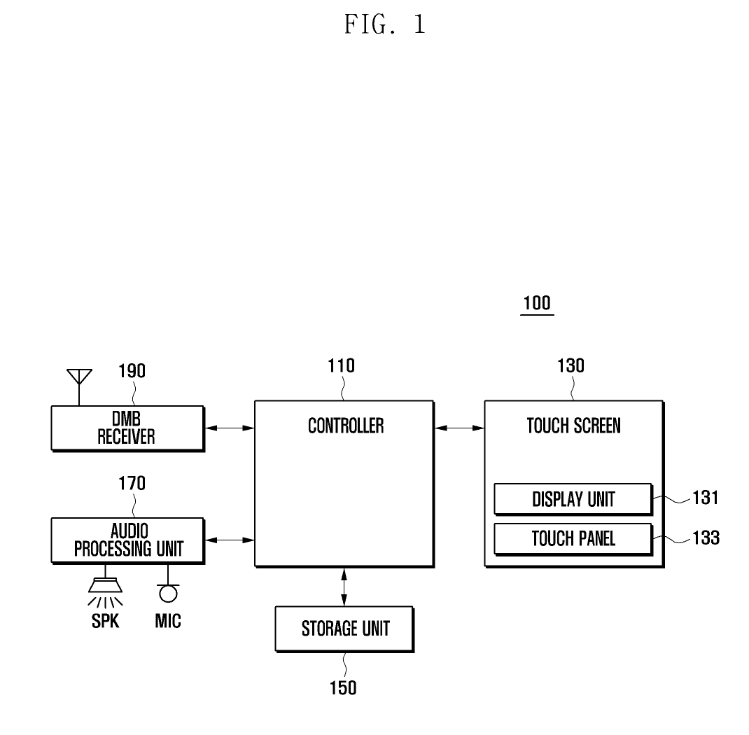

FIGS. 1 through 7, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

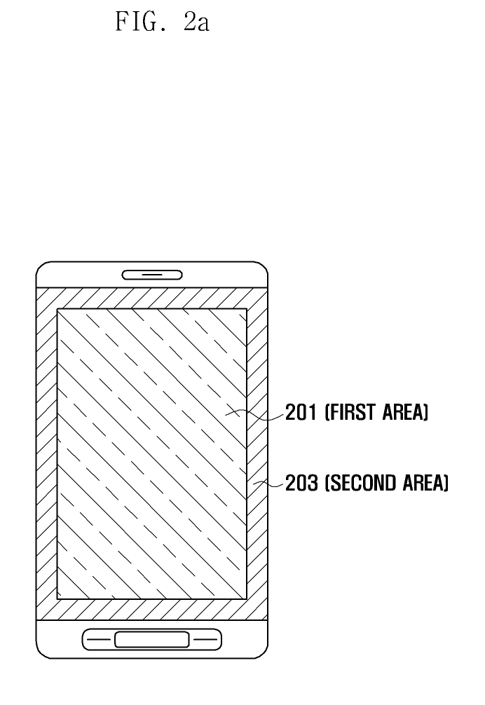

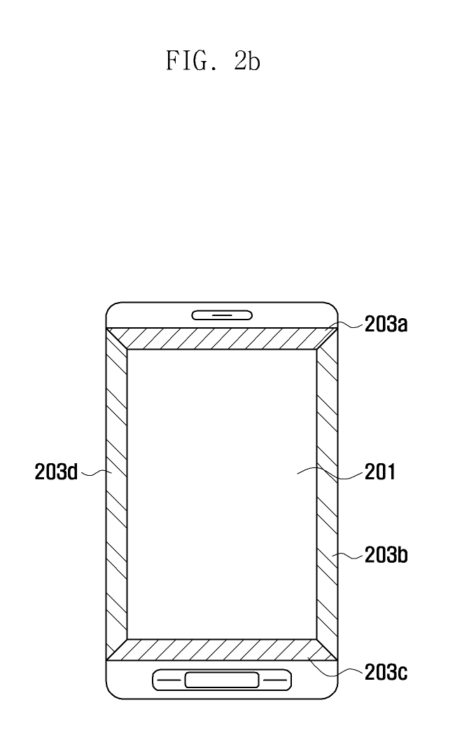

In the following description, a configuration and an operation of a mobile device, according to an exemplary embodiment of the present invention, is explained with reference to FIGS. 1, 2A and 2B.

FIG. 1 illustrates a schematic block diagram of a mobile device according to an exemplary embodiment of the present invention.

Referring to FIG. 1, a mobile device 100 includes a touch screen 130, a storage unit 150, an audio processing unit 170, a Digital Multimedia Broadcast (DMB) receiver 190, and a controller 110.

The mobile device 100, according to an exemplary embodiment of the present invention, can detect an input of a drag gesture that is made on a touch panel 133 as a user's finger or an object moves from a position in an area corresponding to the display unit 131 to a position outside the area corresponding to the display unit 131, where the touch panel 133 has an area larger than the area corresponding to the display unit 131. Therefore, the mobile device 100 can maximize the usable space in the installation of the touch screen 130. The configuring of the mobile device 100 is described in detail below.

The touch screen 130 detects the input of a touch event and performs a display function. The touch screen 130 includes a display unit 131 and a touch panel 133. The display unit 131 displays screens activated when the mobile device 100 is operated. For example, the display unit 131 can display any or all of a booting screen, an idle screen, a call screen, an application executing screen of the mobile device 100, and the like. The display unit 131 can also provide other screens related to the states and operations of the mobile device 100. The display unit 131 may be implemented with a Liquid Crystal Display (LCD), an Organic Light Emitting Diode (OLED), and the like. More particularly, when a user's finger or an object touches one of the icons on the display screen of the display unit 131, the touched icon is displayed in a thick highlighted edge. When the user drags the touched icon, the display unit 131 shows the icon that is being dragged.

The touch panel 133 detects a user's touch, creates a touch event, and outputs a signal corresponding to the created touch event to the controller 110. The touch panel 133 can create a touch down event, a drag event, a touch up event, and the like. A touch down event occurs when a user's finger or an object contacts or touches the touch panel 133. A drag event occurs when a user's finger or an object moves a certain distance on the touch panel 133 in a certain direction at a certain speed, without losing contact with the touch panel 133. A touch up event occurs when a user's finger or an object is lifted off from the touch panel 133. The touch down, drag event and touch up event may contain information about a location where a touch is input. A touch may be created by a touch tool, for example, a user's finger, a stylus pen, and the like. The touch panel 133 may be implemented with various types of touch sensors, for example, capacitive overlay type sensors, resistive overlay type sensors, infrared beam type sensors, pressure sensors, and the like. It should be understood that exemplary embodiments of the present invention are not limited to the sensors listed above. For example, the touch panel 133 can be implemented with all types of sensors as long as they can detect touch or pressure. In an exemplary embodiment of the present invention, the touch panel 133 is attached to the display unit 131. The touch panel 133 has an area larger than the area corresponding to the display unit 131.

FIGS. 2A and 2B illustrate examples of a touch screen according to an exemplary embodiment of the present invention.

Referring to FIGS. 2A and 2B, the touch panel 133 divides its area into a first area 201 and a second area 203. The first area 201 corresponds to the area of the display unit 131. The second area 203, as shown in FIG. 2A, may be designed in such a way that one user function is assigned to the entire area of the second area 203. Alternatively, the second area 203, as shown in FIG. 2B, may be designed in such a way that it is divided into a number of sub-areas 203a, 203b, 203c, and 203d and they may be assigned different user functions.

The storage unit 150 stores programs required to operate the mobile device 100 and data generated when the programs are executed. The storage unit 150 is comprised of a program storage area and a data storage area. The program storage area stores an Operating System (OS) for booting the mobile device 100 and for operating the components in the mobile device 100, and applications for operating functions of the mobile device 100. Examples of the applications are a web browser for connecting to an Internet server, an MP3 application for reproducing audio sources, an image display application for reproducing photographs, a moving image reproducing application, a game application, and the like. In an exemplary embodiment of the present invention, the program storage area can store a touch event process program for processing touch events that occur on the touch panel 133.

The data storage area stores data created when the mobile device 100 is used. For example, the data storage area can store MP3 files, photograph files, moving image files, and the like, which are used by the applications. More particularly, the data storage area can store allocation information about a user function allocated to the second area 203 of the touch panel 133. When a single user function is assigned to the entire area of the second area 203, the data storage area can store the allocation information about the single user function. In contrast, when different user functions are assigned to a number of sub-areas 203a, 203b, 203c and 203d of the second area 203, the storage area can allocate information about at least one of the user functions that will be assigned to the sub-areas, respectively.

The audio processing unit 170 includes COder/DECoders (CODECs). The CODECs are comprised of a data CODEC for processing packet data and an audio CODEC for processing audio signals, such as voice signals, and the like. The audio CODEC converts digital audio signals into analog audio signals and outputs them via a speaker (SPK). The audio CODEC also converts analog audio signals received by a microphone (MIC) into digital audio signals. More particularly, the audio processing unit 170 outputs an audible sound when the mobile device 100 detects a user's drag gesture and performs a particular user function. The audio processing unit 170 may not output the audible sound according to a user's settings.

The Digital Multimedia Broadcast (DMB) receiver 190 receives DMB signals and outputs them to the controller 110. To this end, the DMB receiver 190 includes a receiver for amplifying received low-noise signals and for down-converting the frequency of the received signals. The DMB receiver 190 allows a user to view digital multimedia broadcasts via a DMB receiving application program of the mobile device 100. It should be understood that the DMB receiver 190 is an optional component, and thus it may not be included in the mobile device 100, according to a mobile device manufacturer's purpose.

The controller 110 controls operations of the mobile device 100 such as, signals flowing among the components in the mobile device 100. Examples of the components are the display unit 131, the touch panel 133, the storage unit 150, the audio processing unit 170, and the like. In an exemplary embodiment of the present invention, the controller 110 can detect a user's touch when a touch down event occurs on the touch panel 133. The controller 110 can also detect a user's drag when a drag event occurs on the touch panel 133. Similarly, the controller 110 can conclude that a drag is terminated when a touch up event occurs on the touch panel 133. In that case, the controller 110 can detect the touch location information, contained in the touch down event, as the initial point of the drag event, and the touch location information, contained in the touch up event, as the final point of the drag event. The controller 110 can detect both touch events that occurred in the first and second areas 201 and 203 of the touch panel 133.

When a drag event occurs, starting at a certain location and terminating at another location in the first area 201, the controller 110 performs a general function corresponding to the drag event. An example of the general function is to move an icon according to the drag event and to display it on the display unit 131.

When a drag event occurs starting at a certain location in the first area 201 and terminating at a certain location in the second area 203, the controller 110 can perform a user function assigned to the second area 203. The user function may be previously set in the mobile device 100 or may be set by a user. For example, the user can assign a user function to the second area 203 via a setting menu of the mobile device 100, so that the user function can be performed when a drag event, starting at a certain location in the first area 201 and terminating at a certain location in the second area 203, occurs on the touch panel 133. The second area 203 may be assigned with a single user function. Alternatively, the second area 203 may be divided into a number of sub-areas 203a, 203b, 203c and 203d, so that they can be assigned with different user functions.

The controller 110 can only process the drag event, starting at a certain location in the first area 201 and terminating at a certain location in the second area 203, as a touch event that occurred in the second area 203. When the drag event starts at a certain location in the second area 203, the controller 110 may not perform a function corresponding to the drag event. This is to prevent a user's unintentional touch that may occur in the second area 203, formed at the periphery of the touch panel 133, when the user grips the mobile device 100.

In the foregoing description, the configuration and operation of the mobile device 100 has been explained. The following description provides an exemplary method for operating a touch panel of a mobile device, referring to the accompanying drawings.

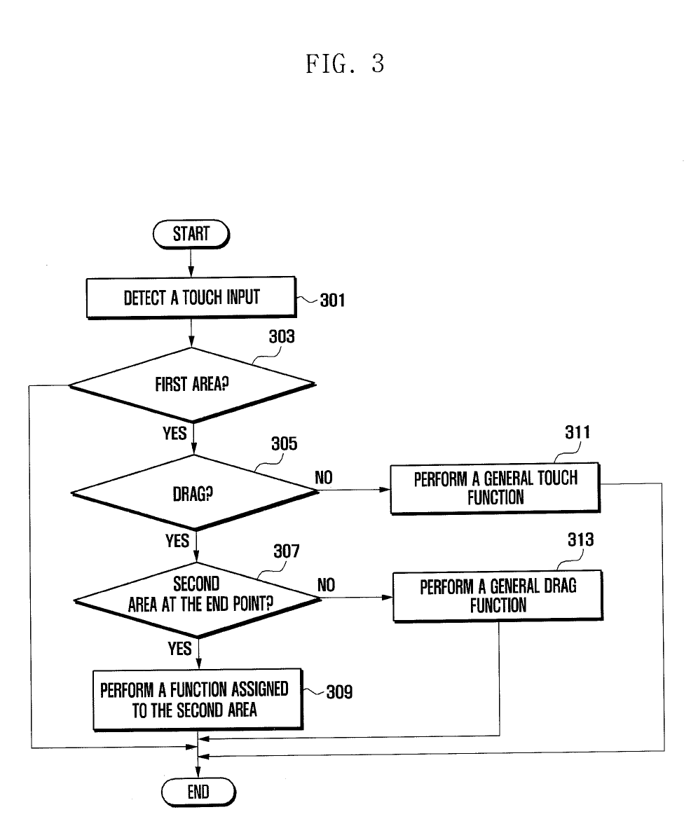

FIG. 3 is a flowchart that describes a method for operating a touch panel of a mobile device according to an exemplary embodiment of the present invention.

Referring to FIGS. 1 to 3, the controller 110 assigns a particular user function to the second area 203 of the touch panel 133, according to a user's input, and stores it in the data storage area of the storage unit 150. That is, the controller 110 receives a particular user function, input by a user via a setting menu, and assigns it to the second area 203. The user can assign different user functions to the second area 203 by respective application programs executed in the mobile device 100. When the user functions are assigned to the second area 203 by respective application programs, the second area 203 may be assigned with a single user function. Alternatively, the second area 203 may be divided into a number of sub-areas 203a, 203b, 203c and 203d, so that they are assigned with different user functions.

After setting the user function, the controller 110 detects a touch event, for example, a touch down event, on the touch panel 133, according to a user's touch input in step 301.

In step 303, the controller 110 determines whether the touch down event occurs in a first area 201, based on the touch location information contained in the touch down event. If it is determined in step 303 that the touch down event has occurred in a first area 201, the controller 110 determines whether a drag event occurs on the touch panel 133 in step 305.

If it is determined in step 305 that a drag event has occurred on the touch panel 133, the controller 110 determines whether the drag event is terminated in the first area 201 or the second area 203 in step 307. That is, the controller 110 can determine whether the final position of the drag event is in the first area 201 or second area 203, based on the location information about a touch up event that occurs on the touch panel 133 when the drag event is terminated.

If it is determined in step 307 that the final position of the drag event is in the second area 203, the controller 110 performs the user function assigned to the second area 203 in step 309. When a single user function is assigned to the entire area of the second area 203, the controller 110 can perform the user function via a currently operated application program. On the contrary, the second area 203 may be divided into a number of sub-areas 203a, 203b, 203c and 203d, and they may be assigned with different user functions. In that case, the controller 110 can perform a user function assigned to one of the sub-area 203a, 203b, 203c and 203d, where the drag event is terminated.

In contrast, if it is determined in step 305 that a drag event has not occurred on the touch panel 133, the controller 110 performs a general function corresponding to the touch down event in step 311. The general function refers to functions that the conventional mobile device can perform according to a user's touch input. An example of the general function is that the controller 110 highlights the edge of an icon, with a thick highlighted line, selected by a touch down event, on the display unit 131. This illustrates that the icon has been selected. Another example of the general function is that the controller 110 performs a function assigned to the selected icon.

In addition, if it is determined in step 307 that the terminal location of the drag event is not in the second area 203 but in the first area 201, the controller 110 performs a general function corresponding to the drag event in step 313. For example, the controller 110 moves an icon in the first area 201 on the display unit 131 from a location where the drag event starts to another location where the drag event is terminated.

Meanwhile, when the touch down event has not occurred in a first area 201 at step 303, the controller 110 terminates the procedure for operating the touch panel 133.

As described above, the method for operating a touch panel 133 can allow the mobile device 100 to maximize the usable space in the installation of the touch screen. When a drag event occurs starting at a certain location in the first area 201 and terminating at a certain location in a second area 203 of the touch panel 133, the method allows the controller 110 to perform a user function assigned to the second area 203, thereby maximizing the usable space when the touch screen 130 is installed to the mobile device 100.

In the following description, exemplary embodiments applied to some application programs are explained with reference to the accompanying drawings.

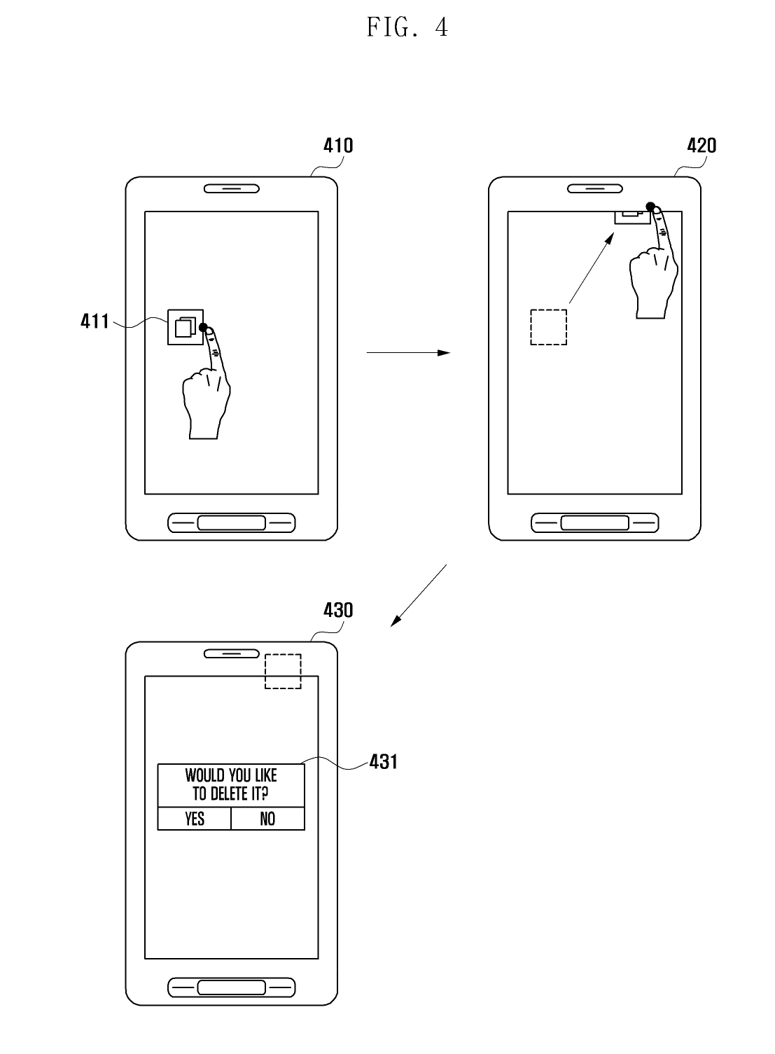

FIG. 4 illustrates display screens of a mobile device when a user manages a file management program in a mobile device according to an exemplary embodiment of the present invention.

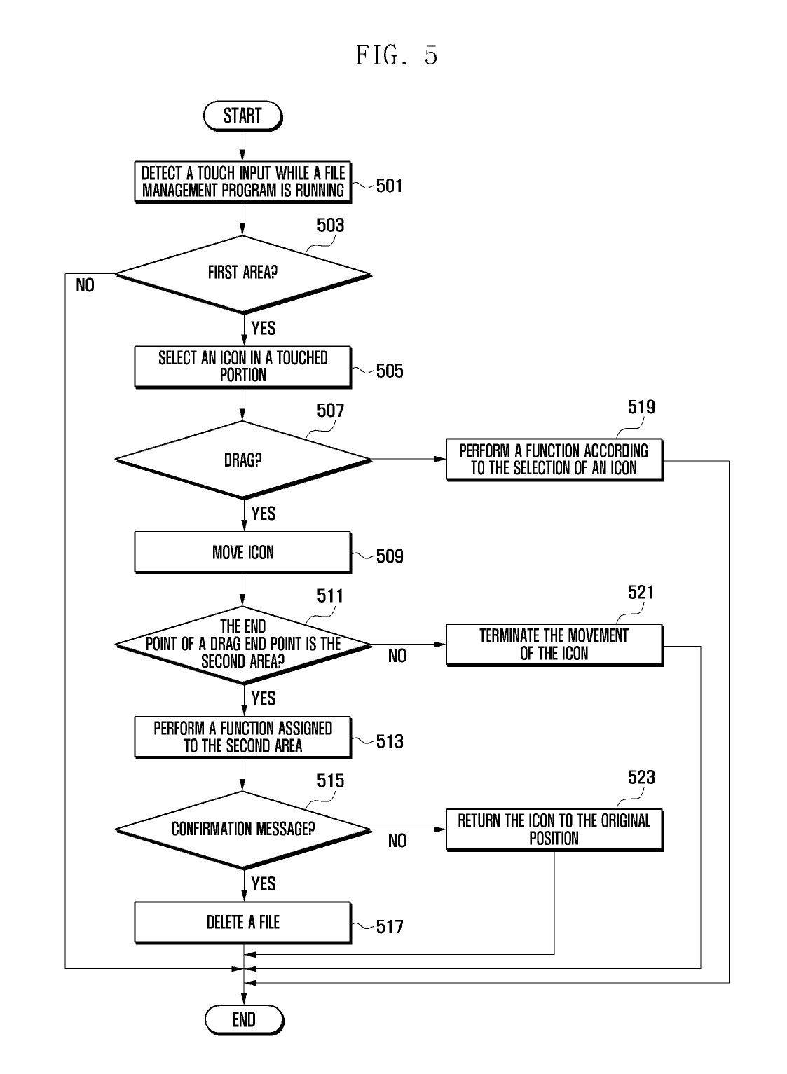

FIG. 5 is a flowchart that describes a method for operating a file management program of a mobile device according to an exemplary embodiment of the present invention.

It is assumed that a single user function is assigned to the entire area of the second area 203 of the touch panel 133. It is also assumed that the second area 203 has a deletion function.

Referring to FIG. 4, the display screen according to the execution of the file management program is comprised of a selection screen 410, a drag screen 420, and a confirmation screen 430.

The selection screen 410 allows a user to select an icon 411 on the display unit 131 via the file management program. The user touches and selects an icon 411 representing a file, displayed on the display unit 131.

The drag screen 420 allows the user to drag the icon 411 selected on the selection screen 410. The user can conduct a drag gesture as he/she touches the touch panel 133 with a touch tool and moves it without losing the contact. In an exemplary embodiment of the present invention, the drag gesture is effective even in an area outside the display unit 131.

The confirmation screen 430 displays a pop-up message 431 asking the user whether the selected icon 411 should be deleted. When the user selects “Yes” to delete the selected icon 411, the file management program deletes the icon 411 and the file represented by the icon 411. On the contrary, when the user selects “No”, the file management program returns the icon 411 to its original position.

Referring to FIG. 5, the controller 110 detects a touch event, for example, a touch down event, on the touch panel 133, according to a user's touch input, while the file management program is being executed in step 501.

In step 503, the controller 110 determines whether the touch down event occurs in a first area 201, based on the touch location information contained in the touch down event. If it is determined in step 503 that the touch down event has occurred in a first area 201, the controller 110 selects an icon 411 where the touch down event has occurred in step 505. The controller 110 displays the selected icon 411 by highlighting its edge in a thick highlighted line, thereby distinguishing it from other non-selected icons.

Thereafter, the controller 110 determines whether a drag event occurs on the touch panel 133 in step 507. If it is determined in step 507 that a drag event has occurred on the touch panel 133, the controller 110 moves the icon 411 in step 509. That is, the controller 110 moves and displays the icon 411 on the display unit 131 according to the drag event. When the drag event is terminated, i.e., a touch up event occurs, the controller 110 determines whether the position where the drag event has been terminated is located in the first area 201 or the second area 203 in step 511. That is, the controller 110 can detect the position where the drag event has been terminated, based on the location information contained in the touch up event.

If it is determined in step 511 that the position where the drag event has been terminated is located in the second area 203, the controller 110 performs a user function assigned to the second area 203 in step 513. In an exemplary embodiment of the present invention, the user function assigned to the second area 203 is to delete a selected file. To do this, the controller 110 can control the display unit 131 to display a pop-up message 431 asking the user whether to delete a file represented by the icon 411 selected in step 505.

In step 515, the controller 110 determines whether a user's selection regarding the pop-up message 431 is input. If it is determined in step 515 that the user has input a selection to delete a file represented by the icon 411, the controller 110 deletes the file in step 517. That is, the controller 110 controls the display unit 131 to delete the icon 411 from the display screen and also controls the storage unit 150 to delete the file represented by the icon 411. The controller 110 may also control the audio processing unit 170 to output an audible sound indicating that the file has been deleted according to a user's settings.

Meanwhile, if it is determined in step 503 that the touch down event has not occurred in a first area 201 but in the second area 203, the controller 110 may not respond to the touch down event.

In contrast, if it is determined in step 507, that a drag event has not occurred on the touch panel 133, the controller 110 performs a general function corresponding to the selected icon in step 519. The general function refers to functions that the conventional mobile device can perform according to a user's touch input. An example of the general function is that the controller 110 controls the display unit 131 to display a photograph on the display screen. Another example of the general function is that the controller 110 controls the audio processing unit 170 to output an audible sound corresponding to an audio source via the speaker.

Similarly, if it is determined in step 511 that the position where the drag event has been terminated is located in the first area 201, the controller 110 stops moving the icon 411 in step 521.

In addition, if it is determined in step 515 that the user has decided not to delete a file represented by the icon 411, the controller 110 returns the selected icon 411 to its original position in step 523. That is, the controller 110 returns the mobile device 100 to the state before it detected the touch down event.

In the foregoing description, an exemplary embodiment has been described where a single user function is assigned to the entire area of the second area 203 on the touch panel 133. The following description provides an exemplary embodiment where the second area 203 is divided into a number of sub-areas 203a, 203b, 203c and 203d and they are assigned with different user functions.

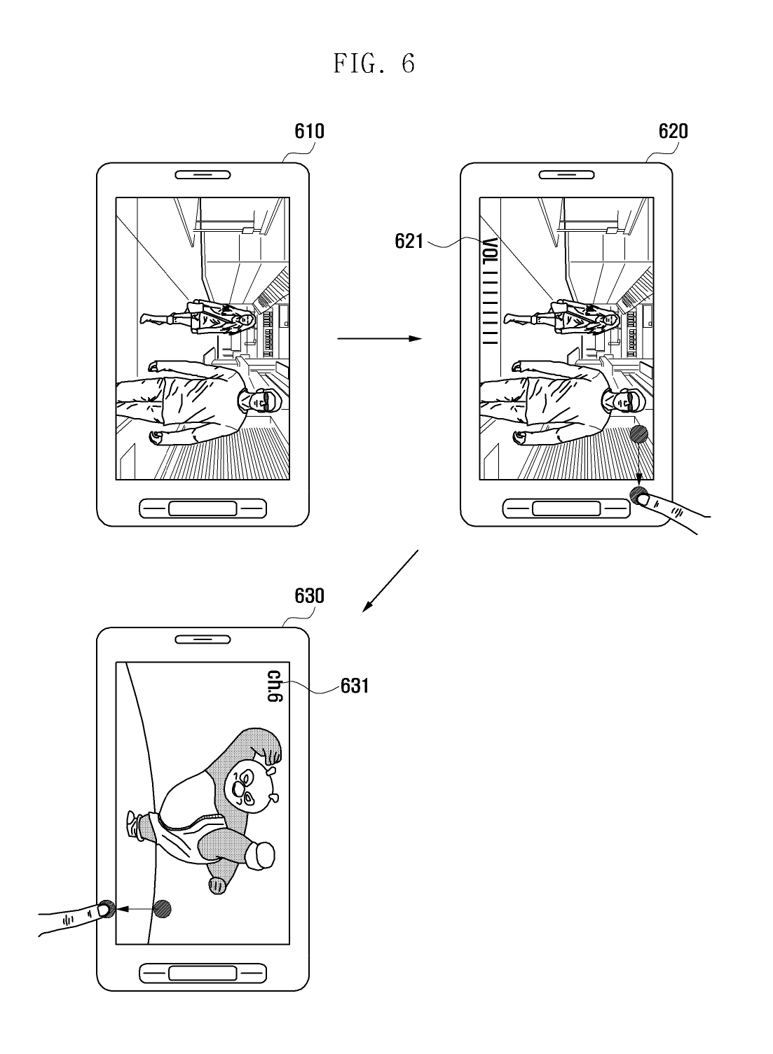

FIG. 6 illustrates a display screen of a mobile device when a user manages a DMB receiving program according to an exemplary embodiment of the present invention.

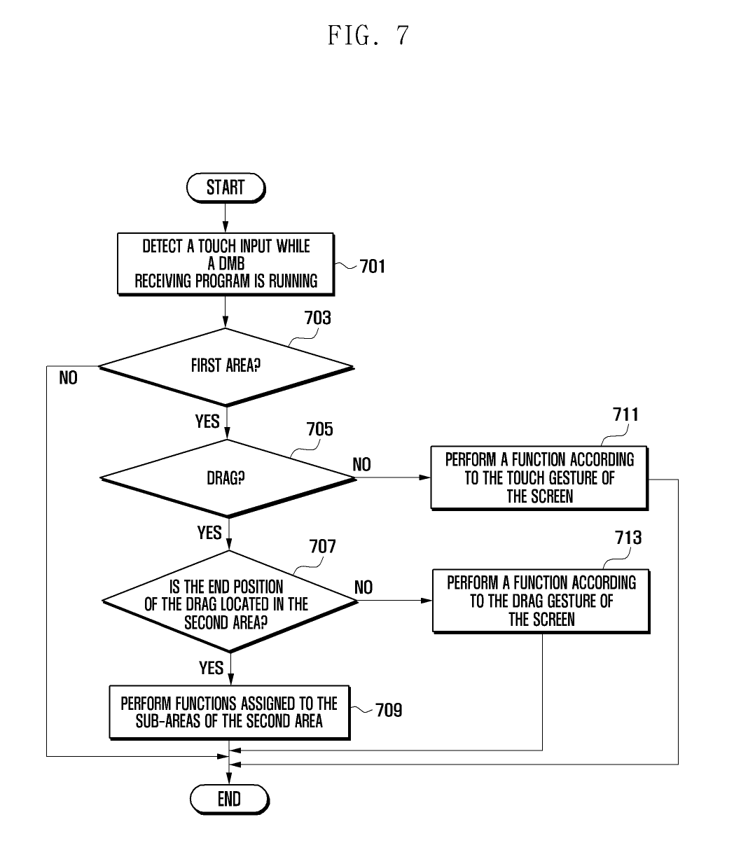

FIG. 7 is a flowchart that describes a method for operating a DMB receiving program, according to an exemplary embodiment of the present invention.

It is assumed that the four sub-areas 203a, 203b, 203c and 203d of the second area 203 are assigned to a volume down function, a channel up function, a volume up function, and a channel down function, respectively.

Referring to FIG. 6, the display screen, according to the execution of the DMB receiving program, is comprised of a broadcast view screen 610, volume adjustment screen 620 and channel selection screen 630.

The broadcast view screen 610 appears when the DMB receiving program is being executed in the mobile device 100. The display unit 131 displays video information about broadcasts, received by the DMB receiver 190 via the DMB receiving program, on the broadcast view screen 610. The audio processing unit 170 can also output audio information about the received broadcast.

The volume adjustment screen 620 appears when volume is adjusted on the broadcast view screen 610. The display unit 131 displays a volume bar 621 showing a currently set volume magnitude on the volume adjustment screen 620.

The channel selection screen 630 appears when a channel is switched on the broadcast view screen 610. The display unit 131 displays a current channel number via a channel title 631 on the channel selection screen 630.

Referring to FIG. 7, the controller 110 detects a touch event, for example, a touch down event, on the touch panel 133, according to a user's touch input in step 701.

In step 703, the controller 110 determines whether the touch down event occurs in a first area 201 or a second area 203, based on the touch location information contained in the touch down event. If it is determined in step 703 that the touch down event has occurred in a first area 201, the controller 110 determines whether a drag event occurs on the touch panel 133 in step 705.

If it is determined in step 705 that a drag event has occurred on the touch panel 133, the controller 110 determines whether the position where the drag event has been terminated is located in the first area 201 or the second area 203, based on the touch location information contained in a touch up event that occurred when the drag event is terminated, in step 707. If it is determined in step 707 that the position where the drag event is terminated is located in the second area 203, the controller 110 performs one of the user functions assigned to the sub-areas 203a, 203b, 203c, and 203d, where the drag event is terminated, in step 709. For example, when the drag event is terminated at a position in the sub-area 203c, the controller 110 controls the audio processing unit 170 to increase the volume by one level and simultaneously controls the display unit 131 to display the volume bar 621 reflecting the current volume. Similarly, when the drag event is terminated at a position in the sub-area 203d, the controller 110 controls the DMB receiver 190 to move the currently receiving DMB channel down by one channel and simultaneously controls the display unit 131 to display the current channel number via the channel subtitle 631.

If it is determined in step 705 that a drag event has not occurred on the touch panel 133, the controller 110 performs a general function corresponding to the touch down event in step 711. For example, when a touch down event occurs on the broadcast view screen 610, the controller 110 controls the display unit 131 to display a channel subtitle 631 on the display screen without switching the channel number.

If it is determined in step 707 that the position where the drag event is terminated is located in the first area 201, the controller 110 performs a general function corresponding to the drag event in step 713. For example, when a drag event occurs on the broadcast view screen 610, the controller 110 controls the display unit 131 to adjust the brightness of the broadcast view screen 610.

In addition, if it is determined in step 703 that the touch down event has not occurred in a first area 201 but in a second area 203, the controller 110 may not perform a function corresponding to the touch down event.

As described above, the mobile device according to exemplary embodiments of the present invention can increase the usable space in the installation of a touch screen. The method of the invention can efficiently operate the touch panel of the touch screen.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A mobile device comprising:
a touch panel for dividing an area into a first area and a second area, where the size of the first area corresponds to that of a display unit; and
a controller for performing user functions according to touch events that occur on the first area and the second area.

2. The mobile device of claim 1, further comprising:
a storage unit for storing assignment information about a user function to be performed according to a touch event that occurred on the second area.

3. The mobile device of claim 1, further comprising, when the area of the second area is divided into a number of sub-areas:
a storage unit for storing assignment information about at least one of the user functions to be performed according to a corresponding one of the touch events that occurred on the sub-areas.

4. The mobile device of claim 1, wherein the controller activates a user function assigned to the second area according to at least one of a touch down event that occurred on the first area, a drag event that occurred as a drag gesture moves from the first area to the second area, and a touch up event that occurred on the second area.

5. The mobile device of claim 1, wherein the controller ignores a touch event that initially occurs on the second area.

6. The mobile device of claim 1, further comprising a Digital Mobile Broadcasting (DMB) receiver.

7. The mobile device of claim 1, wherein a user function is assigned to the entire area of the second area.

8. The mobile device of claim 3, wherein each one of the divided sub-areas of the second area is assigned a different user function.

9. The mobile device of claim 4, wherein the controller does not perform a user function corresponding to the drag event if the drag event starts at a certain location in the second area and terminates at a certain location in the first area.

10. A method for operating a touch panel that has an area larger than a display unit, the method comprising:
dividing an area of the touch panel into a first area and a second area, where the size of the first area corresponds to that of a display unit;
detecting touch events that occur on the first area and the second area; and
performing a user function according to the touch event.

11. The method of claim 10, further comprising:
assigning a user function to the second area.

12. The method of claim 10, further comprising:
dividing the area of the second area into a number of sub-areas; and
assigning user functions to the sub-areas, respectively.

13. The method of claim 10, wherein the detecting of touch events comprises:
detecting a touch down event that occurred on the first area;
detecting a drag event that occurred when a drag gesture moved from the first area to the second area; and
detecting a touch up event that occurred on the second area.

14. The method of claim 10, wherein the detecting of touch events comprises:
ignoring a touch event that initially occurs on the second area.
